(19) United States
(12) Patent Application Publication
(10) Pub. No.: US 2020/0000077 A1
(43) Pub. Date: Jan. 2, 2020

(54) Device for Clarifying and Enhancing Liquid for Improved Luring of Flying Insects

(71) Applicant: Maxtech Mosquito Control Inc., Waterloo (CA)

(72) Inventors: Kailash C. Vasudeva, Ontario (CA); Mark Smith, Ontario (CA)

(21) Appl. No.: 16/490,756

(22) PCT Filed: Mar. 2, 2018
(86) PCT No.: PCT/CA2018/050246

§ 371 Date: Sep. 3, 2019

Related U.S. Application Data
(60) Provisional application No. 62/466,538, filed on Mar. 3, 2017.

(51) Int. Cl. A01M 1/02; A01M 1/10; A01M 1/06

(52) U.S. Cl. CPC A01M 1/026; A01M 1/06; A01M 1/106

(57) ABSTRACT

Disclosed is a device for clarifying and enhancing liquid for improved luring of insects. The device comprises a segregator for collecting eggs and larvae present in the liquid and a unit for receiving an additive and releasing the additive into the liquid passing through the segregator. The additive may be an insect attractant or luring substance, dye of cleaner. Also disclosed is an apparatus for reducing populations of aquatically hatched insects comprising the device.

### FIELD OF THE INVENTION

The present invention is directed to pest control. More specifically, the present invention is directed to controlling the population of flying insects, including mosquitos.

### BACKGROUND OF THE INVENTION

It is known that some flying insects, such as flies and mosquitos, lay their eggs on the surface of fresh or standing water. The water may be in, for example, tin cans, barrels, horse troughs, ornamental ponds, swimming pools, puddles, creeks, ditches, catch basins, marshy areas, flower pots or used tires. More environmentally friendly methods of controlling fly or mosquito populations have involved trapping or destroying the eggs or larvae before they have a chance to mature or capturing the gravid female before or after laying its eggs. In some cases, this has involved providing artificial breeding pools, referred to as ovitraps, which attract gravid flying insects and provide the opportunity to eliminate the eggs and/or larvae from the pool before the insects mature and become airborne.

For example, U.S. Pat. No. 6,708,443 discloses an apparatus where the artificial breeding pool contains a filter that traps the eggs and larvae and then exposes the captured biomass to air causing the biomass to dry and thus be eliminated. U.S. Pat. No. 6,990,768 discloses a similar apparatus with the exception that the filter is provided in the form of a belt that captures the biomass and then passes it through a crushing mechanism to eliminate the eggs and larvae.

Currently, there is no device that can be specifically used to eliminate eggs and larvae from standing water and enhance the water for improved luring of insects.

Furthermore, it is well known that insect larvae is good fish food and fishing bait. However, there is no practical method of producing insect larvae due to the undesired possibility of increasing the insect population. Therefore, there is also a need in the field for a device to collect larvae from standing water or artificial breeding pools for fish bait or food.

### SUMMARY OF THE INVENTION

According to an aspect of the present invention, there is provided a device for clarifying and enhancing liquid for improved luring of flying insects comprising:
a suitable segregator for passing the liquid therethrough having openings sized sufficiently small to collect insect eggs and larvae and permit the passage of the liquid;
a unit for receiving an additive and releasing the additive into the liquid passing through the segregating device; and
a housing for retaining the segregator and unit.

In a further embodiment of the device described above and throughout, the housing comprises an outer wall and an inner wall defining an outer space formed between the outer wall and inner wall and an inner space formed by the inner wall.

In a further embodiment of the device described above and throughout, the segregator is contained in the outer space and the unit is contained in the inner space.

In a further embodiment of the device described above and throughout, the housing comprises openings to allow the liquid to exit the device and the inner wall comprises openings to allow the liquid to enter the outer space from the inner space.

In a further embodiment of the device described above and throughout, the unit comprises apertures for releasing the additive.

In a further embodiment of the device described above and throughout, the additive is an insect attractant or luring substance, dye or cleaner.

In a further embodiment of the device described above and throughout, the insect attractant or luring substance is whey powder or cooked whey powder.

In a further embodiment of the device described above and throughout, the dye indicates the extent of segregator usage wherein an amount of dye in the liquid resulting from the passage of the liquid through the device is indirectly proportional to the extent of segregator usage.

In a further embodiment of the device described above and throughout, the dye indicates a need to clarify the liquid wherein the decomposition of the dye in the liquid after a sufficient period of time is indicative of a need to clarify the liquid.

In a further embodiment of the device described above and throughout, the segregator is composed of a natural fiber.

In a further embodiment of the device described above and throughout, the segregator is crushed to produce fish bait or fish food when embedded with a sufficient amount of insect eggs and larvae.

In a further embodiment of the device described above and throughout, the device is for use in a standing liquid or artificial breeding pool.

According to an aspect of the present invention, there is provided an apparatus for reducing populations of aquatically hatched insects comprising:
a trap assembly comprising a housing retaining a suction mechanism for drawing insects into the housing and a capture chamber for collecting the insects;
a reservoir below the trap assembly for retaining a liquid, the reservoir having a drain opening;
a gap defining a space between the trap assembly and reservoir;
a device for clarifying and enhancing the liquid for improved luring of the insects securable to the reservoir to receive the liquid from the reservoir via the drain opening, the device comprising a segregator having openings sized sufficiently small to collect eggs and larvae of the insects and permit the passage of the liquid, a unit for receiving an additive and releasing the additive into the liquid passing through the segregator, and a housing for retaining the filter and unit; and
a valve between the drain opening and the device for selectively opening and closing the drain opening.

In a further embodiment of the apparatus described above and throughout, the segregated liquid is returned to the reservoir.

In a further embodiment of the apparatus described above and throughout, the suction mechanism is activated by detection of vibration or sound of an insect in the gap.

In a further embodiment of the apparatus described above and throughout, the activation of the suction mechanism is delayed upon detection of vibration or sound to allow the insect to oviposition in the liquid.

In a further embodiment of the apparatus described above and throughout, the suction mechanism has multiple speeds.

In a further embodiment of the apparatus described above and throughout, the additive is an insect attractant or luring substance, liquid cleaner, or dye.

The material and structure of elements formulating this device could be selected based upon desired application. In other words, there could be various versions of the device. Alternatively, the device could carry these multiple elements and could be selectively used for desired application.

### BRIEF DESCRIPTION OF THE DRAWINGS

FIG. 1 is an embodiment of the device of the present invention;

FIG. 2 is the exploded view of the device of FIG. 1;

FIG. 3 is an embodiment of the device in use with an artificial breeding pool; and

FIG. 4 is an embodiment of an apparatus for controlling the insect population.

### DETAILED DESCRIPTION OF THE INVENTION

The following description is of illustrated embodiments by way of example only and without limitation to the combination of features necessary for carrying the invention into effect.

In the context of the present invention, flying insects preferably encompass pest insects that oviposition on water, for example, but not limited to mosquitoes and black flies.

According to an aspect of the present invention, there is provided a device for clarifying and enhancing liquid for improved luring of flying insects. The device comprises a segregator for passing the liquid therethrough having openings sized sufficiently small to collect insect eggs and larvae and permit the passage of the liquid, and a unit for receiving an additive and releasing the additive into the liquid passing through the segregator. A housing retains the segregator and unit.

In a further embodiment, the housing comprises an outer wall and an inner wall defining an outer space formed between the outer wall and inner wall and an inner space formed by the inner wall. The segregator may be contained in the outer space and the unit may be contained in the inner space. Alternatively, the unit may be contained on the outside wall for easy manipulation of the unit, for example when replacing the additive.

In an even further embodiment, the housing comprises openings to allow the liquid to exit the device and the inner wall comprises openings to allow the liquid to enter the outer space from the inner space. In a further embodiment, the unit comprises apertures for releasing the additive and allowing the liquid to pass through.

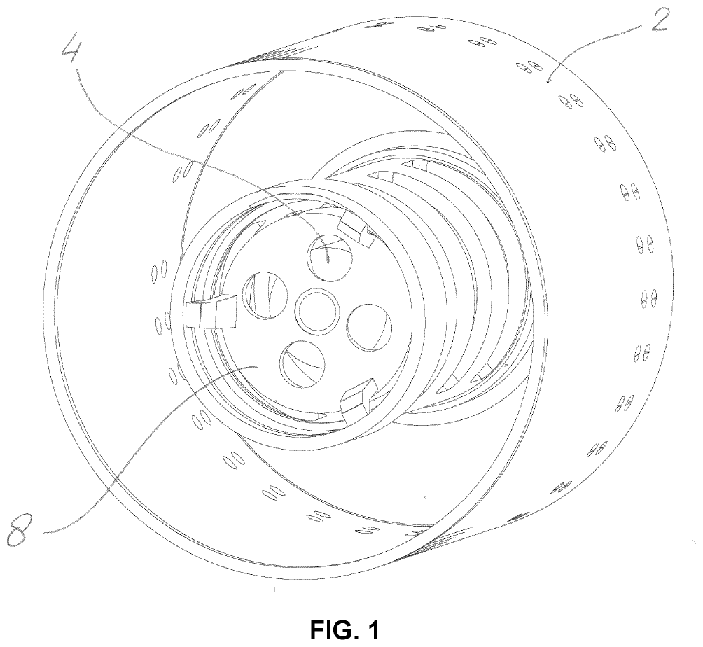

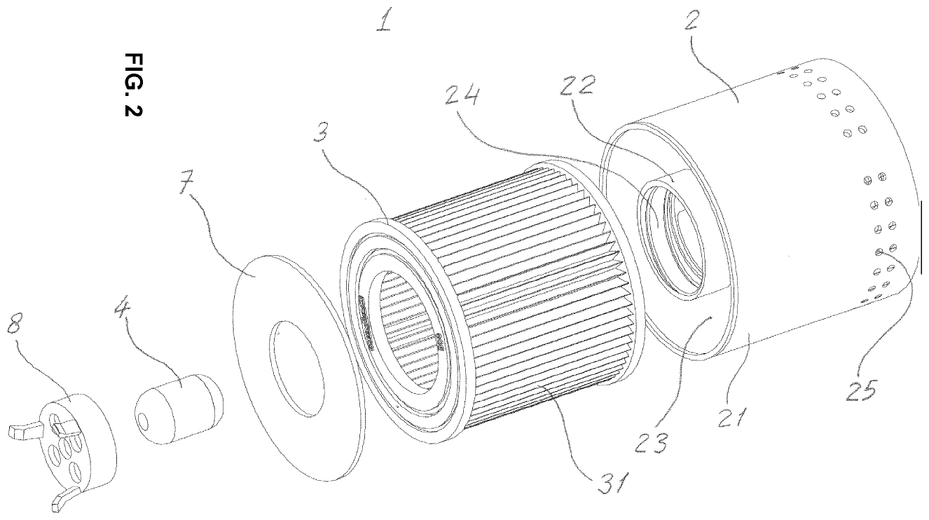

FIGS. 1 and 2 depict the embodiments described above. The device 1 comprises a housing 2, segregator 3 and unit 8 comprising an additive 4. The housing 2 includes an outer wall 21, inner wall 22, outer space 23 formed between the outer wall 21 and inner wall 22 and inner space 24 formed by the inner wall 22. The segregator 3 is contained in the outer space and the unit 8 is contained in the inner space. The outer wall 21 has openings 25 to allow the liquid to exit the device 1 and the inner wall 22 has holes (not shown) to allow the liquid to enter the outer space from the inner space 24.

For cleansing the liquid and enhancing the liquid for improved luring of insects, the liquid first enters inner space 24 and contacts the additive 4 in the unit 8, wherein the additive 4 or at least a portion of the additive 4 is passed into the liquid; secondly, the liquid enters the outer space 23 through the holes on the inner wall 22; thirdly, the liquid passes though the segregator 3, where insect eggs and larvae in the water are captured on the segregator 3; and eventually, the treated liquid can flow out of the device 1 through the openings 25 on the outer wall 21.

One example of the segregator 3 comprises a filter film/fin 31 folded along the axial direction of the segregator 3. However, any other type of segregator is contemplated provided that the openings in the filter are sized sufficiently small to collect eggs and larvae of the insects and permit the passage of the liquid.

The housing 2 may be composed of any material, such as plastic, wood or rubber. It is known that mosquitoes prefer to lay eggs in discarded tires holding water, therefore, the housing 2 may be made of rubber, especially rubber from waste tires, or plastic mixed with rubber or waste tires. It is preferred that the housing 2 is dark in colour to attract insects. The housing 2 may also be made from biodegradable substances.

Optionally, to hold the segregator 3 inside of the housing 2, a cover 7 could be included for keeping the segregator 3 in the outer space 23.

The additive may be any substance that aids in the process of luring insects to the liquid and clarifying the liquid. The additive may be slowly released into the liquid and persist in the unit for many segregation passes or may be used up in one segregation pass. In one embodiment, the additive is an insect attractant or luring substance, dye or cleaner.

The insect attractant or luring substance may include, for example, but not limited to whey powder, cooked whey powder, hay/grass infusion substances, octenol, octenol derivatives, insect pheromones, insect secretions, and any substance typically added to an oviposition medium to lure insects.

In one embodiment of the device, the dye indicates the extent of segregator usage wherein an amount of dye in the liquid resulting from the passage of the liquid through the device is indirectly proportional to the extent of segregator usage. As water passes through the segregator, an amount of dye in the unit will be consumed and the more water that passes through, the more dye will be consumed. In this way, the amount of the dye in the liquid will decrease, providing a visual indicator that the segregator has been utilized many times.

In another embodiment, the dye indicates a need to clarify the liquid wherein the decomposition of the dye in the liquid after a sufficient period of time is indicative of a need to clarify the liquid. As is known, mosquito larvae hatch in about 6 to 10 days and therefore the eggs need to be eliminated from the liquid before they can hatch or if the eggs do hatch, before the larvae can mature and escape the liquid. The dye in the liquid could decompose gradually due to light and heat. By choosing a suitable dye that can be decomposed in 6 to 10 days, the lack of colour in the liquid may indicate that it is time to clarify the liquid to eliminate eggs and larvae. This would be especially helpful when managing multiple artificial breeding pools or ovitraps, or larger spaces such as ponds and lakes.

Examples of the dye are new coccine (CAS number 2611-82-7) or Rosolic Acid (CAS number: 603-45-2), but it should not be limited to these two dyes. One skilled in the art would be familiar with selecting acceptable dyes or tinting materials for the desired purpose.

The cleaner includes any substance that can clean the water or eliminate any unwanted materials. For example, the cleaner includes, without being limiting, substances that eliminate the chlorine in the liquid, so as to improve its attractiveness to insects.

Furthermore, the additive could also include any genetic modifying material, which can genetically modify insects, especially mosquitoes that carry agents that can cause disease in humans.

It is contemplated that the unit may receive one or more than one additive, for example different types of insect attractant or luring substances, dyes or cleaners, or a combination of these additives.

The filter may be composed of fibres, such as cotton, paper or any synthetic fabrics. Preferably, the segregator is composed of a natural fibre.

The device described herein that has run for a while and has embedded a sufficient amount of insect eggs and larvae needs to be replaced. The used filter, which is made out of fibre, could be separated from the device and crushed to produce fish bait or fish food. This would be a good nutritional source for fish. Additionally, this substance can be used as the insect attractant or luring substance additive.

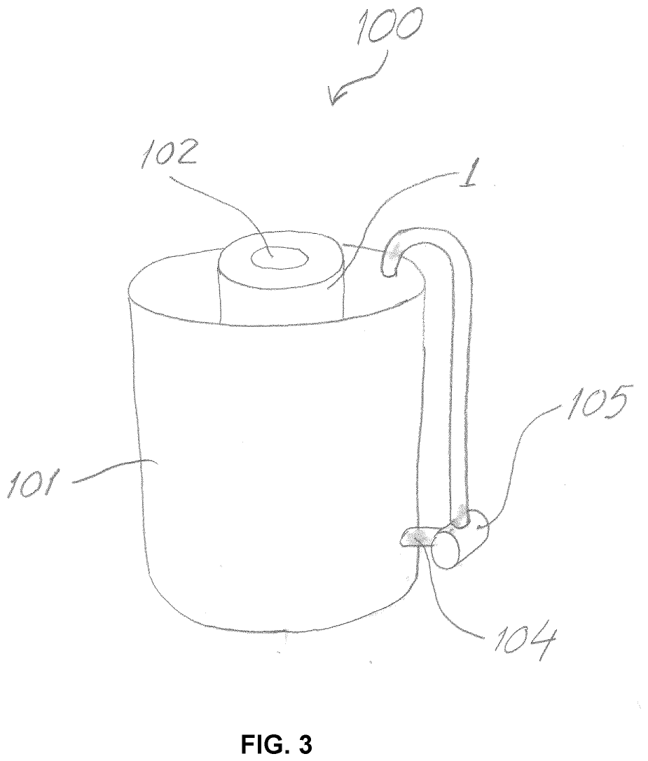

In one embodiment of the present invention, the device is for use in a standing liquid or artificial breeding pool. The device could be used directly on an ovitrap, such as the ovitrap in U.S. Pat. No. 8,844,465. It could also be used on the outlet of a catching basin as in U.S. Pat. No. 8,844,465B. It could be screwed on, pressed onto, clamped on or affixed to the outlet of the catch basin. It could also be used on an inlet of a container. An example of this is shown in FIG. 3.

As shown in FIG. 3, the apparatus 100 includes a container 101, which has an inlet 102 and the device 1 of the present invention installed thereunto. Liquid that needs to be clarified is poured through the inlet 102, passing through the device 1 to capture eggs and larva and to add the additive into the liquid which enters the container 101. To recycle the liquid back, the device 100 includes an outlet 104 at the bottom. Optionally, a pump 105 could also be included to transfer the liquid back. As insects such as mosquitoes lay their eggs in the liquid, they release chemicals that attract more mosquitoes. Therefore, recycling this liquid improves the luring characteristics of the liquid, especially if a mosquito attractant or luring substance is used as the additive. This apparatus 100 could be used to eliminate mosquitos in standing water of surroundings so as to decrease the mosquito population.

The present invention also provides for an apparatus for reducing populations of aquatically hatched insects comprising a trap assembly comprising a housing retaining a suction mechanism for drawing insects into the housing and a capture chamber for collecting the insects; a reservoir below the trap assembly for retaining a liquid, the reservoir having a drain opening; a gap defining a space between the trap assembly and reservoir; a device for clarifying and enhancing the liquid for improved luring of the insects securable to the reservoir to receive liquid from the reservoir via the drain opening. The device comprises a segregator having openings sized sufficiently small to collect insect eggs and larvae and permit the passage of the liquid, a unit for receiving an additive and releasing the additive into the liquid passing through the filter, and a housing for retaining the filter and unit. The apparatus further comprises a valve between the drain opening and the device for selectively opening and closing the drain opening.

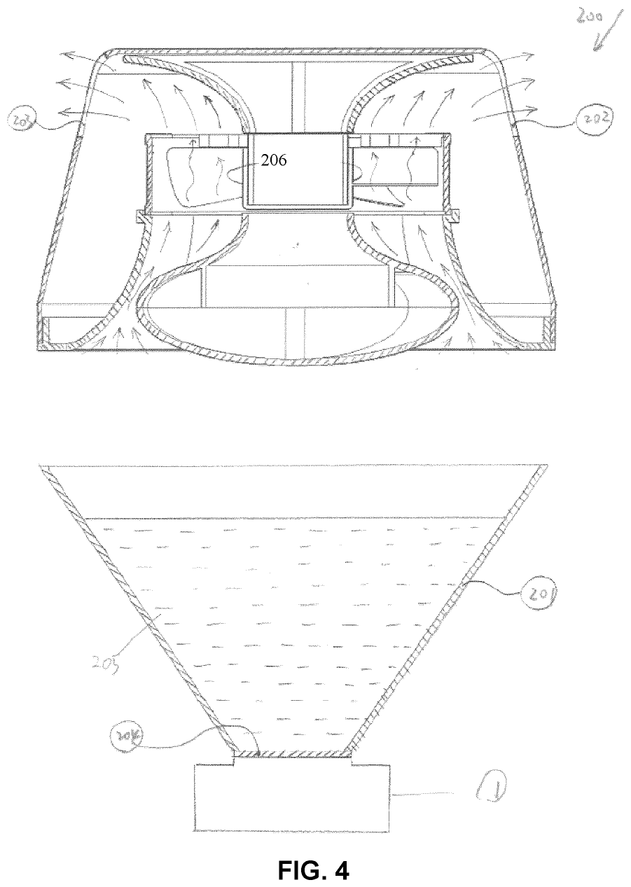

An embodiment of this apparatus is depicted in FIG. 4. The apparatus 200 includes a trap assembly 202 on the top and reservoir 201 at the bottom. The trap assembly 202 can sit on the top of the reservoir 201 with a gap that allows insects to access both.

The reservoir 201 includes a container 205, in which liquid can be kept creating a standing water environment either naturally or by adding attractant from the unit of the device for attracting insects. The container has a drain opening and a gate valve 204 is connected to the drain opening. The device 1 is attached to the drain opening. When the gate valve 204 is open, liquid from the reservoir 201 flows through the device 1. Eggs and larvae in the liquid are collected in the device 1. At the same time, the additive retained in the device 1 enters the liquid. The liquid could be collected and recycled back to the container. Optionally, a pump and a pipe could be included to recycle the liquid back to the container 205.

The trap assembly 202 includes a suction mechanism 206 with a sucking force to draw mosquitos to a capture chamber 203 above the fan. The suction mechanism 206 could be controlled by a timer and a sensor. The sensor could be a vibration sensor or sound senor stored near the gap. When mosquitos approach, the sensor senses the vibration or the sound of the mosquito and activates the suction mechanism 206.

The suction mechanism could be run at a low speed to capture live mosquitos in the chamber 203. The suction mechanism could also be run at a high speed to kill mosquitos and deposit the dead mosquitos in the chamber 203. Further, the suction mechanism could have a speed switch to allow the user to change the speed depending on the need. For example, if live mosquitos are required, the suction mechanism could be run at low speeds. For instance, if a genetic modifying substance is added to the liquid in container 205 via the device, the mosquitos that come to the liquid laying eggs could be captured live for genetic study.

As is known, while mosquitos lay eggs, they release natural pheromones in the water. These pheromones are natural, effective attractants to lure more mosquitos. Therefore, it is advantageous to allow the mosquito to lay its eggs first and then be captured. Therefore, the fan should be activated after the insect lays its eggs. A delayed timer could be included for controlling the suction mechanism activation.

In one embodiment, when insects attracted to the attractant in the liquid approaches the liquid to lay eggs, the sensor senses the insect and triggers the timer of the fan controller. After the mosquito lays its eggs, the timer activates the suction mechanism to draw the mosquito to the capturing chamber 203.

The insects captured in the chamber could be either dead or alive. The live insects could be used for study while the dead insects could be used to produce fish food or be used as an additive for the device. In case gravid mosquitos are captured before laying eggs, there may be a shortage of pheromones which attract insects. In this case, a small portion of crushed gravid insects could be added to the liquid in container 205.

It will be appreciated that the above description relates to the preferred embodiments by way of example only. Many variations of the invention will be obvious to those knowledgeable in the field, and such obvious variations are within the scope of the invention as described and claimed, whether or not expressly described.

What is claimed is:

1. A device for clarifying and enhancing liquid for improved luring of flying insects comprising:
a segregator for passing the liquid therethrough having openings sized sufficiently small to collect insect eggs and larvae and permit the passage of the liquid;
a unit for receiving an additive and releasing the additive into the liquid passing through the filter; and
a housing for retaining the segregator and unit.

2. The device of claim 1, wherein the housing comprises an outer wall and an inner wall defining an outer space formed between the outer wall and inner wall and an inner space formed by the inner wall.

3. The device of claim 2, wherein the segregator is contained in the outer space and the unit is contained in the inner space.

4. The device of claim 3, wherein the housing comprises openings to allow the liquid to exit the device and the inner wall comprises openings to allow the liquid to enter the outer space from the inner space.

5. The device of claim 1, wherein the unit comprises apertures for releasing the additive.

6. The device of claim 1, wherein the additive is an insect attractant or luring substance, dye or cleaner.

7. The device of claim 6, wherein the insect attractant or luring substance is whey powder or cooked whey powder.

8. The device of claim 6, wherein the dye indicates the extent of segregator usage wherein an amount of dye in the liquid resulting from the passage of the liquid through the device is indirectly proportional to the extent of segregator usage.

9. The device of claim 6, wherein the dye indicates a need to clarify the liquid wherein the decomposition of the dye in the liquid after a sufficient period of time is indicative of a need to clarify the liquid.

10. The device of claim 1, wherein the segregator is composed of a natural fiber.

11. The device of claim 1, wherein the segregator is crushed to produce fish bait or fish food when embedded with a sufficient amount of insect eggs and larvae.

12. The device of claim 1, for use in a standing liquid or artificial breeding pool.

13. An apparatus for reducing populations of aquatically hatched insects comprising:
a trap assembly comprising a housing retaining a suction mechanism for drawing insects into the housing and a capture chamber for collecting the insects;
a reservoir below the trap assembly for retaining a liquid, the reservoir having a drain opening;
a gap defining a space between the trap assembly and reservoir;
a device for clarifying and enhancing the liquid for improved luring of the insects securable to the reservoir to receive the liquid from the reservoir via the drain opening, the device comprising a segregator having openings sized sufficiently small to collect eggs and larvae of the insects and permit the passage of the liquid, a unit for receiving an additive and releasing the additive into the liquid passing through the filter, and a housing for retaining the segregator and unit; and
a valve between the drain opening and the device for selectively opening and closing the drain opening.

14. The apparatus of claim 13, wherein the filtered liquid is returned to the reservoir.

15. The apparatus of claim 13, wherein the fan is activated by detection of vibration or sound of an insect in the gap.

16. The apparatus of claim 15, wherein the activation of the suction mechanism is delayed upon detection of vibration or sound to allow the insect to oviposition in the liquid.

17. The apparatus of claim 13, wherein the suction mechanism has multiple speeds.

18. The apparatus of claim 13, wherein the additive is an insect attractant or luring substance, liquid cleaner, or dye.
